(19) United States
(12) Patent Application Publication
(10) Pub. No.: US 2025/0200180 A1
(43) Pub. Date: Jun. 19, 2025

(54) Malware Encryption Detection - Host Encrypted Data Communication Algorithm

(71) Applicant: International Business Machines Corporation, Armonk, NY (US)

(72) Inventors: Beth Ann Peterson, Tucson, AZ (US); Matthew G. Borlick, Tucson, AZ (US); Clint A. Hardy, Tucson, AZ (US); Lokesh Mohan Gupta, Tucson, AZ (US)

(21) Appl. No.: 18/540,932

(22) Filed: Dec. 15, 2023

(51) Int. Cl. G06F 21/56

(52) U.S. Cl. CPC G06F 21/566

(57) ABSTRACT

Malware encryption detection for host data are provided. The host data is associated with an expected encryption state which includes at least one of an encrypted state, a partially encrypted state, or an unencrypted state. An actual encryption state for the host data is determined based on a first comparison between an expected compression ratio of the host data and an actual compressed ratio of the host data. A tag is stored for the host data based on a second comparison between the actual encryption state of the host data and the expected encryption state of the host data.

### BACKGROUND

The disclosure generally relates to the field of computer security, and more particularly, to detecting malware through the detection of encrypted data communication.

Malware is a fusion of words malicious and software and encompasses a wide array of software designed with the intent to infiltrate or disrupt computer systems without the informed consent of the system owner. Malware represents a broad category encompassing various forms of hostile, intrusive, or unwanted software or program code, often targeting unsuspecting computer users. As malware attacks become more frequent, attention has begun to shift from viruses and spyware protection to malware protection, and programs have been developed to specifically combat them. However, modern malware and other unauthorized software within an enterprise typically rely upon encrypted communications for either commands or control or for identification of distribution nodes for peer-to-peer network applications.

Since these malware and other unauthorized software communications are encrypted, it is not typically possible to investigate the actual data being communicated. Thus, current technologies for malware detection are insufficient from a protection perspective when the malware utilizes encrypted communication. Thus, malware remains an ongoing problem for computer users and/or service providers.

### SUMMARY

According to an aspect of the disclosure a computer-implemented method is provided, which includes receiving host data associated with an expected encryption state of the host data, where the expected encryption state includes at least one of an encrypted state, a partially encrypted state, or an unencrypted state. The computer-implemented method further includes determining an actual encryption state for the host data based on a first comparison between an expected compression ratio of the host data and an actual compressed ratio of the host data and storing a tag for the host data based on a second comparison between the actual encryption state of the host data and the expected encryption state of the host data.

According to another aspect of the disclosure, a system is provided, that includes a processing circuitry configured to receive host data associated with an expected encryption state of the host data, where the expected encryption state includes at least one of an encrypted state, a partially encrypted state, or an unencrypted state. The processing circuitry may be further configured to compress the host data using a compression model based on an expected compression ratio. The processing circuitry may be further configured to determine, based on an output of the compression model, an actual compressed ratio of the host data. The processing circuitry may be further configured to determine an actual encryption state for the host data based on a first comparison between the expected compression ratio of the host data and the actual compressed ratio of the host data. The processing circuitry may be further configured to store a tag for the host data based on a second comparison between the actual encryption state of the host data and the expected encryption state of the host data.

According to another aspect of the disclosure, a computer program product for malware encryption detection is provided. The computer program product comprises a computer readable storage medium having program instructions, which when executed by a system, causes the system to receive host data associated with an expected encryption state of the host data, where the expected encryption state includes at least one of an encrypted state, a partially encrypted state, or an unencrypted state. The system may be further configured to determine an actual encryption state for the host data based on a first comparison between an expected compression ratio of the host data and an actual compressed ratio of the host data. The system may be further configured to store a tag for the host data based on a second comparison between the actual encryption state of the host data and the expected encryption state of the host data and update the stored tag for the host data to indicate malicious data based on the determination that the expected encryption state of the host data indicates the unencrypted state and the actual encryption state of the host data indicates the encrypted state.

Additional technical features and benefits are realized through the techniques of the disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The following description will provide details of preferred embodiments with reference to the following figures wherein:

FIG. 1 is a diagram that illustrates an example computing environment, in accordance with an embodiment of the disclosure;

FIGS. 2A-2B are diagrams that illustrate network environments including an exemplary storage device configured for malware encryption detection, in accordance with an embodiment of the disclosure;

FIG. 3 is a flowchart that illustrates an exemplary method for implementing a handshake protocol for encryption state communication, in accordance with an embodiment of the disclosure;

FIG. 4A is a diagram that illustrates a data block of a legacy host device, in accordance with an embodiment of the disclosure;

FIG. 4B is a diagram that illustrates an exemplary data block received from an exemplary host device configured for encryption state communication, in accordance with an embodiment of the disclosure;

FIG. 4C is a diagram that illustrates example communication blocks used for encryption state communication, in accordance with an embodiment of the disclosure;

FIG. 5 is a flowchart of an exemplary method for malware encryption detection, according to an embodiment of the disclosure; and

FIG. 6 is a flowchart of an exemplary method for compressing host data based on an expected encryption state of the host data, in accordance with an embodiment of the disclosure.

### DETAILED DESCRIPTION

The disclosure generally relates to identifying malicious software and more particularly, to malware encryption detection based on an encryption state communication. Malware and other unauthorized software within an enterprise (e.g., at desktop level and/or server level) typically rely upon encrypted communications for either command, control or for identification of distribution nodes for peer-to-peer network applications. In order to remain undetected, malware uses encryption to conceal the contents of the communications. These encrypted communications may occur at any computer port at any time, and for any length of time. Therefore, there is a need for improved malware encryption detection systems.

Various aspects of the disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated operation, concurrently, or in a manner at least partially overlapping in time. Further, where certain elements of the disclosure can be partially or fully implemented using known components, only those portions of such known components that are necessary for an understanding of the disclosure will be described, and detailed descriptions of other portions of such known components are omitted so as not to obscure the disclosure(s). In the disclosure, an embodiment showing a singular component should not be considered limiting; rather, the disclosure is intended to encompass other embodiments including a plurality of the same component, and vice-versa, unless explicitly stated otherwise herein. Moreover, the applicant does not intend for any term in the disclosure to be ascribed an uncommon or special meaning unless explicitly set forth as such. The disclosure also encompasses present and future known equivalents to the components referred to herein.

A computer program product embodiment (“CPP embodiment” or “CPP”) is a term used in the disclosure to describe a computer-readable medium, e.g., in a set of one or more storage devices, including machine-readable code corresponding to instructions and/or data for performing intended computer operations described herein. A “storage device” may refer to any tangible device that can retain and store data and/or instructions for use by a computer processor. Without limitation, the computer readable medium may include an electronic storage medium, a magnetic storage medium, an optical storage medium, an electromagnetic storage medium, a semiconductor storage medium, a mechanical storage medium, or any suitable combinations of the foregoing. Some known types of storage devices that include these mediums may include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combinations of the foregoing. A computer readable medium, as that term is used in the disclosure, should not be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data may be moved at some occasional points in time during normal operations of a storage device, such as during access, de-fragmentation or garbage collection, but this does not render the storage device as transitory because the data is not transitory while it is stored.

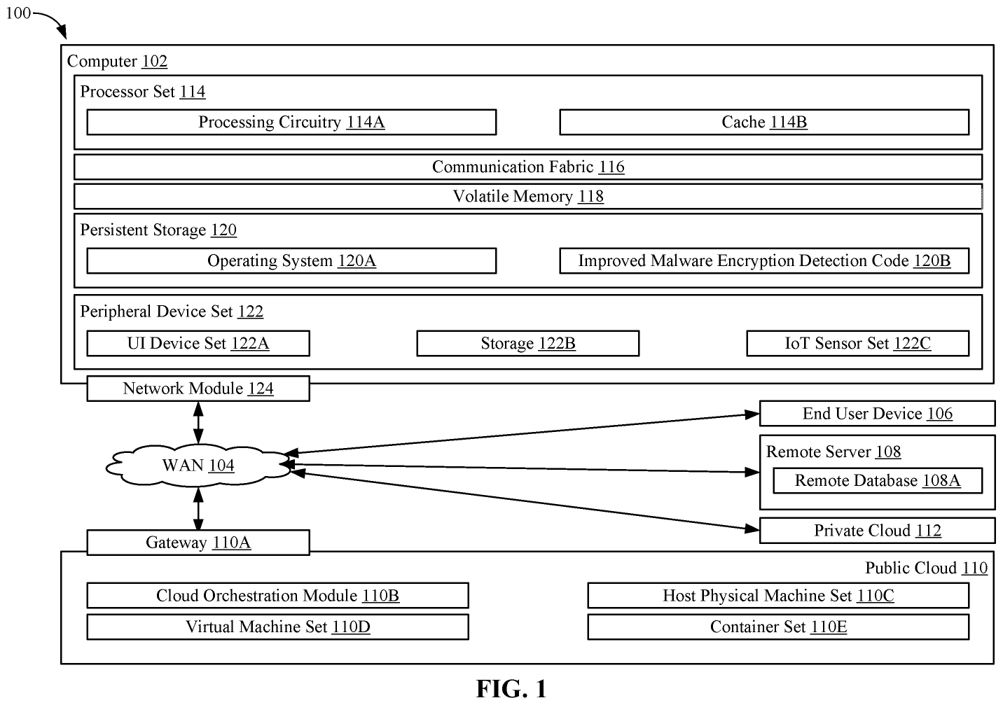

FIG. 1 is a diagram that illustrates an exemplary computing environment 100 for performing exemplary methods described in the disclosure. In the illustrated embodiment, the exemplary methods may be performed by one or more processors, such as a processor set 114, executing exemplary computer codes in one or more computing blocks (or storage blocks) such as an improved malware encryption detection code in a block 120B. In addition to the block 120B, the computing environment 100 may include, for example, a computer 102, a wide area network (WAN) 104, an end-user device (EUD) 106, a remote server 108, a public cloud 110, and a private cloud 112. In this embodiment, the computer 102 includes the processor set 114 (including a processing circuitry 114A and a cache 114B), a communication fabric 116, a volatile memory 118, a persistent storage 120 (including an operating system 120A and the block 120B, as identified above), a peripheral device set 122 (including a user interface (UI) device set 122A, a storage 122B, and an Internet of Things (IoT) sensor set 122C), and a network module 124. The remote server 108 may include a remote database 108A. The public cloud 110 may include a gateway 110A, a cloud orchestration module 110B, a host physical machine set 110C, a virtual machine set 110D, and a container set 110E.

The computer 102 may include a desktop computer, laptop computer, tablet computer, smartphone, smartwatch or other wearable computer, mainframe computer, quantum computer or any other suitable forms of computer or mobile devices now known or to be developed in the future that is capable of running a program, accessing a network, and/or querying a database, such as the remote database 108A. In one embodiment, the computer 102 may be configured as a server or a networked device such as a storage device 202, discussed below in greater detail. The performance of a computer-implemented method performed by the processing circuitry 114A may be distributed among multiple computers and/or between multiple locations. The computer 102 may be connected to a local computing network or, in some examples, operate in communication with a cloud computing network.

The processor set 114 may include one or more computer processors of any suitable type now known or to be developed in the future. The processing circuitry 114A may include hardware distributed over multiple packages, for example, multiple, coordinated integrated circuit chips. The processing circuitry 114A may implement multiple processor threads and/or multiple processor cores. The cache 114B may be a computer memory that is located in the processor chip package(s) and used for data or code that may be available for rapid access by the threads or cores running on the processor set 114. Cache memories such as the cache 114B may be organized into multiple levels depending upon relative proximity to the processing circuitry 114A. Alternatively, some, or all, of the cache 114B for the processor set 114 may be located “off-chip” on a device remotely connected thereto. In some computing environments, the processor set 114 may be configured for working with qubits and performing quantum computing.

Computer readable program instructions may be loaded onto the computer 102 to cause a series of operational steps to be performed by the processor set 114, thereby effecting computer-implemented methods, such as those specified in flowcharts and/or narrative descriptions of computer-implemented methods (collectively referred to as “inventive methods”) described in the disclosure. These computer-readable program instructions may be stored in various types of computer readable media, such as the cache 114B and the persistent storage 120. The program instructions, and associated data, may be accessed by the processor set 114 to control and direct performance of the inventive methods. In the computing environment 100, at least some of the instructions for performing the inventive methods may be stored in the block 120B in the persistent storage 120.

The communication fabric 116 may include any suitable signal communication path configured to provide various components of the computer 102 to communicate with remote devices or with each other. The communication fabric 116 may include switches and electrically conductive paths such as buses, bridges, physical input/output ports and the like. Other types of signal communication paths including fiber optic communication paths and/or wireless communication paths may also be contemplated.

The volatile memory 118 is any suitable type of volatile memory now known or to be developed in the future. Examples of the volatile memory 118 may include dynamic type random access memory (RAM) and static type RAM. In the computer 102, the volatile memory 118 may be located in a single package; however, in some examples, the volatile memory 118 may be distributed over multiple packages and/or located externally with respect to the computer 102.

The persistent storage 120 may refer to any suitable form of non-volatile computer storage that is now known or to be developed in the future. The non-volatility of this persistent storage 120 may indicate that the stored data is retained regardless of whether power is being supplied to the computer 102. In the illustrated example, the persistent storage 120 may be a read-only memory (ROM). The persistent storage 120 may allow writing of data, deletion of data and re-writing of data including remote access thereto. Some familiar forms of the persistent storage 120 include, without limitation, magnetic disks and solid-state storage devices. The operating system 120A may take any suitable types of forms, such as various known proprietary operating systems or open source Portable Operating System Interface-type operating systems that employ a kernel. The exemplary computer code included in the block 120B may assist the processing circuitry 114A (or the storage controller 212) in performing the inventive methods.

The peripheral device set 122 may include a set of one or more peripheral devices that may communicate with other components of the computer 102 in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the Internet. In various embodiments, the UI device set 122A may include components such as a display screen, speaker, microphone, wearable devices (such as goggles and smartwatches), keyboard, mouse, printer, touchpad, game controllers, and haptic devices. The storage 122B may include an external storage, such as an external hard drive, or insertable storage, such as an SD card. The storage 122B may be persistent and/or volatile. In some embodiments, the storage 122B may take the form of a quantum computing storage device for storing data in the form of qubits. In some embodiments where the computer 102 is required to have a large amount of storage (for example, where the computer 102 locally stores and manages a large database), the storage 122B may be configured for storing large amounts of data, such as a storage area network (SAN) that may be shared by multiple, geographically distributed computers. The IoT sensor set 122C may include any suitable types of sensors that can be used in Internet of Things applications. For example, one sensor may be a thermometer and another sensor may be a motion detector; however, any other suitable types of sensors known in the art including temperature sensors, pressure sensors, humidity sensors, gas sensors, vibration sensors, imaging sensors, proximity sensors, inertial measurement unit (IMU) sensors, and optical sensors, may also be implemented.

The network module 124 may include a collection of computer software, hardware, and firmware configured to facilitate communication with other computers through a network such as the WAN 104. The network module 124 may include hardware, such as modems or Wi-Fi signal transceivers, software for packetizing and/or de-packetizing data for communication network transmission, and/or web browser software for communicating data over the Internet. In some embodiments, network control functions and network forwarding functions of the network module 124 may be performed on the same physical hardware device. In other embodiments (for example, embodiments that utilize software-defined networking (SDN)), the control functions and the forwarding functions of the network module 124 may be performed on physically separate devices, such that the control functions manage several different network hardware devices. Computer readable program instructions for performing the inventive methods, in some examples, can be downloaded to the computer 102 from an external computer or external storage device through a network adapter card or network interface included in the network module 124.

The WAN 104 is any wide area network (for example, the Internet) capable of communicating computer data to remote devices by any suitable technology for communicating computer data, now known or to be developed in the future. In some embodiments, the WAN 104 may be replaced and/or supplemented by local area networks (LANs) configured to communicate data between devices connected to a local network, such as a Wi-Fi network. The WAN 104 and/or LANs may include any suitable types of computer hardware such as copper transmission cables, optical transmission fibers, wireless transmission, routers, firewalls, switches, gateway computers and edge servers.

The End-User Device (EUD) 106 may represent any computer system including one or more types of computing devices known in the art, related art, or developed later. The EUD 106 may take any of the suitable forms discussed above in connection with the computer 102. The EUD 106 may receive data and/or instructions based on operations of the computer 102. For example, the computer 102 may be configured to provide a recommendation, e.g., regarding host data to a user, where this recommendation may be communicated using the network module 124 of the computer 102 through the WAN 104 to the EUD 106. The EUD 106 may be further configured to display the received recommendation to a user. In some embodiments, the EUD 106 may be a client device, such as thin client, heavy client, mainframe computer, desktop computer, and so on.

The remote server 108 may represent any computer system including one or more computing devices configured to serve at least some data and/or functionality to the computer 102. In some embodiments, the remote server 108 may be controlled and used by the same entity that operates the computer 102. Other embodiments may include the remote server 108 representing a machine that collects and stores data for use by other computers. For example, where the computer 102 may be programmed to provide a recommendation based on historical data, the remote server 108 may provide such historical data to the computer 102 from the remote database 108A.

The public cloud 110 may represent any computer system including one or more computing devices configured to provide on-demand computer system resources and/or other computer capabilities, especially data storage (cloud storage) and computing power, without direct active management by a user. Cloud computing leverages sharing of such resources to achieve coherence and economies of scale. The direct and active management of computing resources of the public cloud 110 may be performed by the computer hardware and/or software of the cloud orchestration module 110B. The computing resources provided by the public cloud 110 may be implemented by virtual computing environments that may run on various computers of the host physical machine set 110C, which may represent a universe of physical computers in and/or available to the public cloud 110. The virtual computing environments (VCEs) may include virtual machines from the virtual machine set 110D and/or containers from the container set 110E. It would be understood that these VCEs may be stored as system images for intended tasks and may be transferred to or shared among various physical machine hosts after instantiation of the VCE. Examples of these tasks may include, but are not limited to, system backup, recovery, rollback, testing, cloning, and deployment. The cloud orchestration module 110B may manage a transfer and storage of system images, deploy new instantiations of VCEs, and manage active instantiations of VCE deployments. The Gateway 110A may refer to a collection of computer software, hardware, and firmware, independently or collectively, configured to assist the public cloud 110 in communicating through a network such as the WAN 104.

Examples of VCEs may include virtual machines and containers; however, other suitable types of VCEs may also be contemplated. A container may represent a VCE that uses operating-system-level virtualization. The container may refer to an operating system feature in which the kernel allows the existence of multiple isolated user-space instances. These isolated user-space instances may operate as real computers from the point of view of programs running in them. A computer program running on an ordinary operating system can utilize all computational and storage resources of the underlying computer. Examples of these resources may include connected devices, files and folders, network shares, CPU power, and quantifiable hardware capabilities. However, programs running inside a container such as the container set 110E may only use contents stored therewith and devices assigned thereto, a feature which is known as containerization.

The private cloud 112 may be similar to the public cloud 110, except that the computing resources may be only available for use by a single enterprise in some examples. While the private cloud 112 is depicted (in FIG. 1) as being in communication with a network such as the WAN 104, in other embodiments, the private cloud 112 may be disconnected from the Internet entirely and only accessible through a local/private network. A hybrid cloud may represent a composition of multiple clouds of different types (for example, private, community or public cloud types), often respectively implemented by different vendors. Each of the multiple clouds remains a separate and discrete entity, but a larger hybrid cloud architecture may be bound together by standardized or proprietary technology that enables orchestration, management, and/or data/application portability between the multiple constituent clouds. In the illustrated embodiment (FIG. 1), the public cloud 110 and the private cloud 112 may both be part of a larger hybrid cloud.

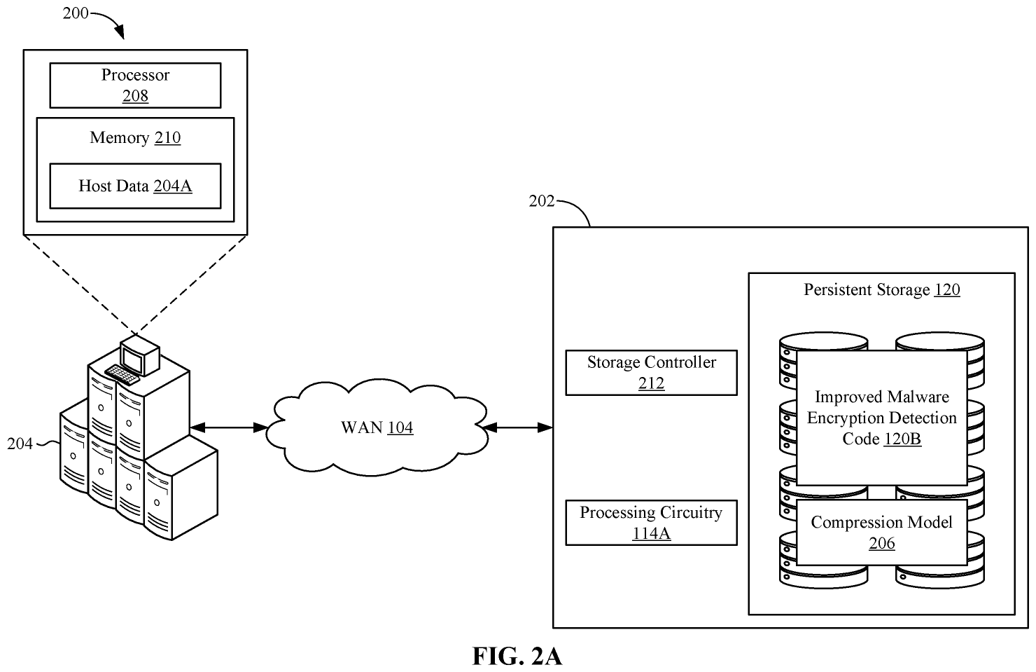

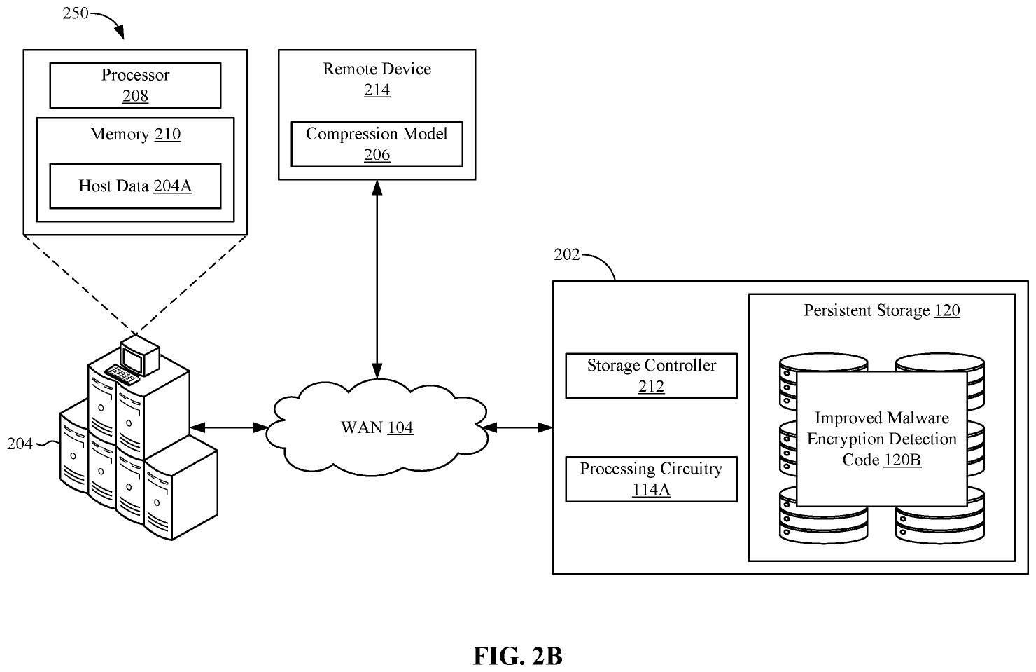

Referring back to FIG. 1, various components of the computing environment 100, for example, the computer 102, the WAN 104, the EUD 106, the remote server 108, the public cloud 110, and the private cloud 112 enable an execution of at least some of the computer code, for example, the improved malware encryption detection code stored in the block 120B. Further, various components of the computer 102, for example, the processor set 114 or an instance of the processor set 114, for example, the processing circuitry 114A may execute the instructions of the improved malware encryption detection code block 120B. Further, in some examples, the cache 114B may increase a speed of data access operations. The volatile memory 118 may temporarily store various types of data that the computer 102 may use in the execution of the improved malware encryption detection code block 120B. The persistent storage 120 may store the operating system 120A, the improved malware encryption detection code block 120B and/or the various types of data. The peripheral devices set 122 may obtain the various types of data that the computer 102 may use in the execution of the improved malware encryption detection code block 120B. In some examples, the peripheral devices set 122 may provide external storage to store the various types of data. In some other examples, the peripheral devices set 122 may receive a user input for the execution of the improved malware encryption detection code block 120B. The network module 124 may allow the computer 102 to communicate with components of network environments (explained with reference to FIG. 2A-2B) via the WAN 104. Further, the remote server 108 may serve various types of data and/or functionality, for example, a recommendation functionality to the computer 102. The public cloud 110 and the private cloud 112 may provide on-demand computing resources and/or a cloud data storage. Further, the EUD 106 may receive an output of the computer 102 for the malware encryption detection in some examples.

FIGS. 2A-2B are diagrams that illustrate network environments including an exemplary storage device 202 configured for malware encryption detection, according to an example embodiment. FIGS. 2A-2B are explained in conjunction with elements from FIG. 1. With reference to FIG. 2A, there is shown a diagram of a network environment 200. In one embodiment, the network environment 200 may include the storage device 202, a host device 204 comprising host data 204A, and a network such as the WAN 104. FIG. 2B illustrates a network environment 250 including the storage device 202, the host device 204, and a remote device 214 including a compression model 206. The storage device 202 may represent an exemplary embodiment of the computer 102. In some examples, the storage device 202 may include or be connected to a storage array in an active-active configuration with the host device 204. In the active-active configuration, the host device 204 may be programmed to access and utilize any logical unit numbers (LUNs) corresponding to specific storage volumes or partitions in the storage device 202. The host device 204 may perform input and output (I/O) operations to LUNs across any of the available access paths for storing data or running applications. The storage device 202 may include suitable logic, circuitry, interfaces, and/or code that may be configured to receive the host data 204A. The storage device 202 may be implemented by way of a single device, (e.g., a computing device, a processor, or an electronic storage device) or a combination of multiple such devices that may be operatively connected or networked together. For example, as illustrated in FIG. 2A, the storage device 202 may include the persistent storage 120 for storing, at least one of, (1) files and related data including metadata, e.g., data size, data format, creation date, associated tags or labels, images, documents, messages or conversations, etc.; (2) a log of profiles of network devices and associated communications including instructions, queries, conversations, data, and related metadata; and (3) predefined or dynamically defined, calculated, manipulated, or used mathematical models, equations, or methods.

In one embodiment, the persistent storage 120 may store the compression model 206, discussed below in greater detail. The storage device 202 may further include, inter alia as discussed above, the processing circuitry 114A and the persistent storage 120 including a storage controller 212 and the exemplary block 120B for configuring the processing circuitry 114A to perform malware encryption detection. The storage controller 212, in communication with the processing circuitry 114A, may be configured to, without limitation, (i) convert data from one format to another, (ii) manage caching and access to stored data, (iii) facilitate mechanisms how data is stored, retrieved, and organized, (iv) compress data and decompress data; (v) calculate a data compression ratio; (vi) facilitate signal analysis; (vii) record clock times and calculate durations; (viii) determine an expected and an actual encryption state of data; (ix) create, associate, update, and/or store one or more tags for data such as host data; (x) support or enhance functionalities of other components such as the processing circuitry 114A, and so on. The storage controller 212 may be configured as software, hardware, or a suitable combination of hardware and software. In some examples, the storage controller 212 may operate in communication with the processing circuitry 114A to perform one or more functions of the storage device 202. Other examples may include the storage controller 212 acting as an intermediary between the processing circuitry 114A and a computer-readable medium in the storage device 202.

In the illustrated embodiment, the processing circuitry 114A in communication with the storage controller 212 may be configured to receive the host data 204A associated with an expected encryption state of the host data 204A. The expected encryption state is the state of encryption that the host device 204 intended to send to the storage device 202. The expected encryption state may correspond to at least one of an encrypted state, a partially encrypted state, or an unencrypted state. For example, when the host device 204 intends to send encrypted communication to the storage device 202, the expected encryption state is the encrypted state. This indicates that the host device 204 is sending encrypted data. The processing circuitry 114A in communication with the storage controller 212 may be further configured to (1) compress the host data 204A using the compression model 206 based on an expected compression ratio, (2) determine, based on an output of the compression model 206, an actual compressed ratio of the host data 204A, (3) determine an actual encryption state for the host data 204A based on a first comparison between the expected compression ratio of the host data 204A and the actual compressed ratio of the host data 204A, and (4) create and store a tag for the host data 204A based on a second comparison between the actual encryption state of the host data 204A and the expected encryption state of the host data 204A. The actual encryption state for the host data 204A is thus derived after the processing circuitry 114 has executed the operations (1)-(4). The actual encryption state is an indication of state of the host data 204A that is inferred at the storage device side. In some examples, the processing circuitry 114A may be configured to cause the storage controller 212 to select a tag for the host data 204A from a predefined group of tags based on a type, source, and/or actual or expected encryption state of the host data 204A. Examples of a type of the host data 204A may include, but are not limited to, text data, audio data, video data, image data, database data, executable and binary data, sensor data, and streaming data, or any combinations thereof. In further examples, the processing circuitry 114A, or the storage controller 212, may be configured to associate or embed the tag with the host data 204A. The tag may be stored in e.g., the persistent storage 120, the host device 204, or the remote device 214, and/or associated with the host data 204A. In one embodiment, the tag may indicate to the storage controller 212 and the processing circuitry 114A (or a remote device) that the host data 204A includes malicious data. Examples of the storage device 202 may include, but are not limited to, a server, a computing device, a mainframe machine, a computer workstation, a smartphone, a cellular phone, a mobile phone, and a consumer electronic (CE) device.

The host device 204 may include suitable logic, circuitry, interfaces, and/or code that may be configured to transmit the host data 204A to the storage device 202. In one embodiment (FIG. 2A), the host device 204 may be configured as a server; however, other embodiments may include the host device 204 being a client device or a standalone computing device. The host device 204 may have any suitable server configuration depending on its intended purpose. Examples of such server configurations may include, but are not limited to, application server, web server, domain name system (DNS) server, dynamic host configuration protocol (DHCP) server, proxy server, virtual private network (VPN) server, database server, and streaming server. The host device 204 may include a processor 208 and a memory 210 for storing (or hosting), extracting, and/or analyzing the host data 204A.

The processor 208 may be configured to communicate synchronously or asynchronously with one or more software applications, databases, appliances, or storage devices (e.g., storage device 202) operating via same or different communication protocols, formats, database schemas, platforms or any combinations thereof, to send and receive a variety of data such as the host data 204A. The processor 208 may be further configured to encrypt one or more layers of data, such as the host data 204A, depending on a type thereof. For example, the processor 208 may perform (i) an application encryption for sensitive data, (ii) database encryption to protect sensitive data at a database level, (iii) file or dataset level encryption for broader protection of sensitive data related to access control, (iv) SAN link encryption, alone or in combination with full disk and tape encryption for a comprehensive protection of sensitive data. In some examples, the processor 208 may enhance or increase the functionality and/or capacity of a network, such as WAN 104, to which it may be connected. In further examples, the processor 208 may also be configured to perform, e.g., notification tasks, security tasks, network management tasks including Internet protocol (IP) address management, and other tasks. Other examples may include the processor 208 being further configured to expose a computing environment or operating code of the host device 204 to a user (or a remote device) and may include related art input or output (I/O) devices, such as a keyboard, a camera, and a display device. The host device 204 of some embodiments may, however, include software, firmware, or other resources that support the remote administration, operation, power control, and/or maintenance of the host device 204 or remote devices such as the storage device 202. Examples of the host device 204 may include, but are not limited to, a mobile device, a smartphone, a cellphone, a consumer device, a personal digital assistant (PDA), a computing device, a mainframe machine, a server, a computer workstation, and/or any other suitable device that can assist in at least storing and/or communicating the host data 204A.

The WAN 104 may include any suitable software, hardware, or computer applications configured to provide a communication medium through which the storage device 202, the host device 204, and the compression model 206 may communicate with each other. In an embodiment, the WAN 104 may include multiple networks or sub-networks, each of which may include a wired connection and/or a wireless connection. Examples of the wired connection or the wireless connection may include, but are not limited to, the Internet, a cloud network, a Wireless Fidelity (Wi-Fi) network, a Personal Area Network (PAN), a Local Area Network (LAN), a Metropolitan Area Network (MAN), and a cellular network. Various devices in the network environment 200 may be configured to connect to the WAN 104 in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), FICON™, 802.16, IEEE 802.11s, IEEE 802.11g, multi-hop communication protocols, cellular communication protocols, and Bluetooth (BT) communication protocols.

In another embodiment, with reference to FIG. 2B, there is shown the network environment 250. The network environment 250 may additionally include the remote device 214 operating in communication with the host device 204 and the storage device 202. The remote device 214 may include, at least in part, the compression model 206 stored therein. The remote device 214 may include or correspond to any suitable computing devices known in the art, related art, or developed later including those mentioned above such as the remote server 108, the EUD 106, the public cloud 110, and the private cloud 112. The remote device 214 may have its own processor, a memory, a transceiver circuit and a display screen to communicate with networked devices. In a first example, the remote device 214 may include or operate as a network appliance. Examples of the network appliance may include, but are not limited to, a Digital Subscriber Line (DSL) modem, a wireless access point, a router, a signal repeater or enhancer, and a gateway having a predetermined computing power and memory capacity sufficient for storing and communicating the compression model 206 and any other data to other networked devices. The network appliance may be configured to establish a network such as the WAN 104 among network devices such as the storage device 202 and the host device 204. In a second example, the remote device 214 may include or operate as a standalone host device in communication with the storage device 202. The standalone host device may be similar to the host device 204; however, some examples may include the standalone host device being different in one or more aspects from the host device 204. Examples of these aspects may include, but are not limited to, computing power, memory or storage capacity, portability, and wearability. The standalone host device may operate independently or in tandem with the host device 204. In a third example, the remote device 214 may operate as a client device or a storage device.

The remote device 214, in some examples, may provide an interface to facilitate the exchange of software instructions and data between the network devices. In further examples, the remote device 214 may assist in implementing a distributed network architecture with or without the storage device 202. For instance, the remote device 214 may be configured to perform one or more functions of the storage device 202 discussed herein. The remote device 214 may execute these functions either independently or in tandem with other network devices such as the storage device 202. The remote device 214 may store, wholly or in-part, the compression model 206. The remote device 214 may be configured to receive, fetch, or access the compression model 206 stored, at least in part, with another networked device connected to a network such as the WAN 104. Other examples may include the remote device 214 being configured to access, or facilitate access to, the compression model 206 stored on another device. For instance, the remote device 214 may include a module (not shown) that may enable the remote device 214 for being introduced to the storage device 202 (or other networked devices), thereby enabling the storage device 202 (or other networked devices) to invoke the remote device 12 as a service to perform the exemplary methods described in the disclosure.

In operation, the storage device 202 may be configured to receive the host data 204A associated with the expected encryption state of the host data 204A, where the expected encryption state may correspond to the encrypted state, the partially encrypted state, or the unencrypted state. In one example, the processing circuitry 114A (or the storage controller 212) may expect to receive the host data 204A in an encryption state indicated by the expected encryption state of the host data 204A. The expected encryption state of the host data 204A may be used to indicate to, e.g., the processing circuitry 114A or the storage controller 212, whether the host data 204A, upon receipt, is expected to be encrypted, partially encrypted, or unencrypted. In one embodiment, the expected encryption state corresponding to the encrypted state may indicate to the processing circuitry 114A (or the storage controller 212) that the expected host data 204A may be encrypted, and that corresponding to the unencrypted state may indicate to the processing circuitry 114A (or the storage controller 212) that the expected host data 204A may be unencrypted. Similarly, the expected encryption state corresponding to the partially encrypted state may indicate to the processing circuitry 114A (or the storage controller 212) that the expected host data 204A may be partially encrypted. In the partially encrypted state, a portion of the host data 204A may be encrypted and the remaining portion of the host data 204A may be unencrypted. In some examples, in the partially encrypted state, the expected encryption state may also include a record including a first size of the encrypted portion of the host data 204A and a second size of the unencrypted portion of the host data 204A. The storage device 202 may receive the host data 204A comprising the expected encryption state of the host data 204A directly from the host device 204; however, some examples may include the processing circuitry 114A (or the storage controller 212) receiving the host data 204A via the remote device 214.

In an embodiment, the processing circuitry 114A (or the storage controller 212) may be configured to initiate an encryption state communication (ESC) prior to receiving the host data 204A, e.g., from the host device 204. The ESC may refer to or include an exemplary handshake protocol configured to assist a device in learning an expected encryption state of data, such as the host data 204A, intended to be received.

In some embodiments, the host device 204 itself initiates the ESC or the handshake protocol to indicate to the storage device 202 expected encryption state of data, such as the host data 204A, intended to be transmitted to the storage device 202.

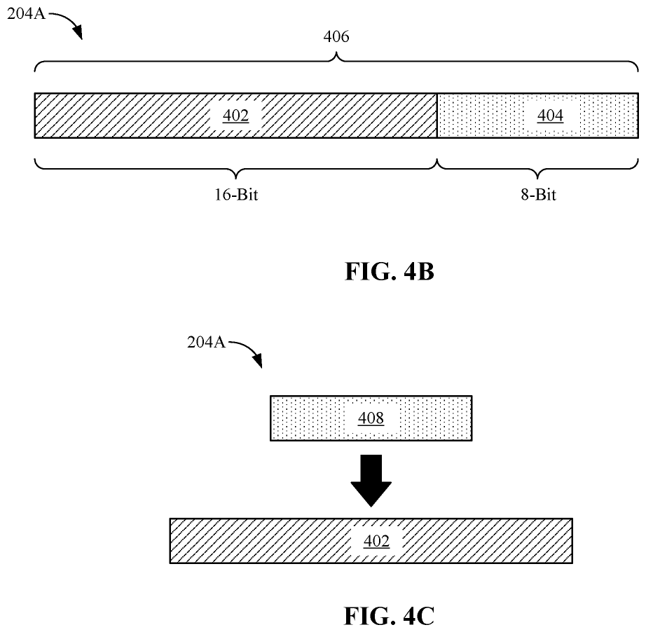

In some embodiments, the ESC is not initiated, rather communication exchange between the host device 204 and the storage device 202, or between the remote device 214 and the storage device 202, is done using communication data blocks that serve as commands indicating the encryption state of the data blocks to be exchanged. These commands are transmitted as prefix data blocks prior to exchanging the actual data blocks between the host device 204 and the storage device 202, or between the remote device 214 and the storage device 202. The different communication exchange blocks are illustrated in detail in conjunction with FIG. 4A, FIG. 4B, and FIG. 4C described later.

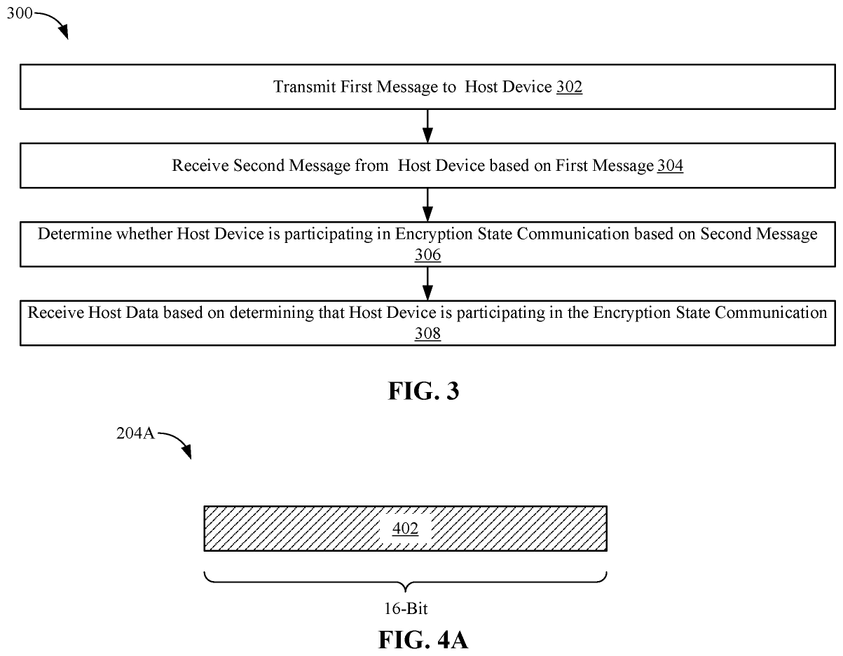

Other embodiments may include the processor 208, or a remote device such as the remote device 214, initiating the encryption state communication with the storage device 202. In the illustrated embodiment, the processing circuitry 114A (or the storage controller 212) may perform an exemplary method of FIG. 3 to implement the handshake protocol for encryption state communication, in communication with a target device.

FIG. 3 is a flowchart that illustrates an exemplary method 300 for implementing an exemplary handshake protocol for encryption state communication, in accordance with an example embodiment of the disclosure. FIG. 3 is explained in conjunction with elements from FIG. 1 and FIGS. 2A-2B. Referring to FIG. 3, there are shown exemplary operations 302 through 308. The operations of the exemplary method 300 may start at 302.

At 302, the storage device 202 transmits a first message to a target device from where data is intended to be received. In a first embodiment, the processing circuitry 114A (or the storage controller 212) may be configured to transmit the first message to a target device such as the host device 204, however, other examples may include the remote device 214 being the target device. The first message may correspond to a handshake packet configured to determine a participation status of the target device such as the host device 204 for the encryption state communication. For example, in a Count Key Data (CKD) Attachment Architecture for the storage device 202, the processing circuitry 114A (or the storage controller 212) may include a parameter “request flag bit” in addressing and control command prefix. The first message may include the parameter “request flag bit” that may be set to a predefined value, e.g., set to ‘1’ indicating a participation status request to the target device such as the host device 204. Alternatively, the “request flag bit” may be set to ‘0’ in the first message may indicate the participation status request. In an embodiment, the processing circuitry 114A (or the storage controller 212) may send the first message to the remote device 214 operating as an interface between the storage device 202 and the host device 204. In some aspects of the disclosure, the remote device 214 may be configured to transmit the received first message to the host device 204. In some aspects of the disclosure, the remote device 214 may communicate with the host device 204 on behalf of the storage device 202 to determine the participation status of the host device 204.

In some embodiments, the host data 204A includes a padding bit pattern, that includes the “request flag bit” for indicating the participation status of the target device in the ESC. This is further described in conjunction with FIG. 4B.

In some embodiments, a prefix command in the form of a prefix data block includes the “request flag bit” for indicating the participation status of the target device in the ESC. This is further described in conjunction with FIG. 4C. In some embodiments, the transmission of the first message may be done from the host device 204 to the storage device 202, when the host device 204 initiates the ESC.

At 304, the storage device 202 receives a second message in response to the first message. In one embodiment, the processing circuitry 114A (or the storage controller 212) may be further configured to receive the second message from the target device, e.g., the host device 204 based on the transmitted first message, where the second message may be a handshake acknowledgement packet that may indicate the participation status of the host device 204 in the encryption state communication. Other embodiments may include the processing circuitry 114A (or the storage controller 212) receiving the second message from or via the remote device 214. For example, the processor 208 of the host device 204 may generate the second message in response to receiving the first message or an indication related thereto. In instances where the host device 204 may be configured to participate in encryption state communication, the processor 208 may include a “response flag bit” in the second message. In one example, the “response flag bit” may be set to a predefined value, e.g., set to ‘1’ indicating a positive participation status, i.e., the target device such as the host device 204 being preconfigured to participate in the encryption state communication. On the other hand, the processor 208 may set the “response flag bit” to ‘0’ in the second message to indicate a negative participation status, i.e., the host device 204 being incapable of participating in the encryption state communication. In some examples, the processor 208 may completely omit the “response flag bit” to indicate the negative participation status. Each of the “request flag bit” and the “response flag bit” (collectively referred to as flag bits) are discussed to have a single bit for the sake of brevity and simplicity; however, other examples may include at least one of the flag bits being multi-bit parameters. In the CKD Attachment Architecture for the storage device 202, the flag bits may assist the processing circuitry 114A (or the storage controller 212) in determining whether or not to expect subsequent write to data (e.g., write data) that may be already encrypted, partially encrypted, or unencrypted.

At 306, the storage device 202 is configured to determine the participation status of the target device based on the second message. In some embodiments, the processing circuitry 114A (or the storage controller 212) may be configured to determine the target device such as the host device 204 to have the negative participation status based on the “response flag bit” set to ‘0’ in the second message. Accordingly, the processing circuitry 114A (or the storage controller 212) may be configured to (i) designate the target device such as the host device 204 as a “legacy host” and (ii) stop the initiation of the encryption state communication based on the host device 204 having the negative participation status. Details about a legacy host device designated as the “legacy host” are provided, for example, in FIG. 4A and related description below.

At 308, the storage device 202 receives the host data 204A based on determining that the host device 204 is participating in the encryption state communication, such as when the “response flag bit” is set to 1. Details about receiving the host data 204A based on determining that the host device 204 is participating in the encryption state communication are provided, for example, in FIG. 4B, FIG. 4C and related description below.

It may be understood by one of ordinary skill in the art, that the operations 302-308 may be initiated at the host device 204 and continued with the storage device 202 equivalently in any order required to enable the ESC between the host device 204 and the storage device 202, without deviating from the scope of the present disclosure.

FIG. 4A is a diagram that illustrates a data block 402 of the legacy host device, in accordance with an example embodiment of the disclosure. FIG. 4A is explained in conjunction with elements from FIG. 1, FIGS. 2A-2B, and FIG. 3.

The data block 402 corresponds to the host data 204A transmitted by the host device 204. The data block 402 corresponds to the host data 204A when the host device is not participating in the encryption state communication with the storage device 202. In this aspect, the host data 204A includes, such as a 16-bit data block 402 without any padding bits. Thus, the host data 204A excludes any data bits corresponding to expected encryption state of the host data 204A. For example, the host device 204 when designated as the “legacy host” may send the data block 402 of the host data 204A to the processing circuitry 114A (or the storage controller 212), where the data block 402 may exclude the expected encryption state of the host data 204A. However, when the host device 204 is participating in the encryption state communication with the storage device 202, as indicated by the ‘response flag bit’ being set to 1 in the second message sent from the host device 204 to the storage device 202, the structure of a data block of the host data 204A is different. This is illustrated in FIG. 4B.

FIG. 4B is a diagram that illustrates an exemplary data block 406 received from the host device 204 configured for encryption state communication, in accordance with an embodiment of the disclosure. FIG. 4B is explained in conjunction with elements from FIG. 1, FIGS. 2A-2B, FIG. 3 and FIG. 4A.

The data block 406 includes the data block 402 of the host data 204A and a padding bit pattern 404 indicative of participation of the host device 204 in the encryption state communication. In an embodiment, based on participating in the encryption state communication, the host device 204 may insert an indication within the host data 204A to indicate the expected encryption state of the host data 204A. For example, the processor 208 may monitor a status of the host data 204A at the host device 204. If the processor 208 determines that the host data 204A may be unencrypted at the host device 204, the processor 208 may include the padding bit pattern 404 within the host data 204A, where the padding bit pattern may correspond to the expected encryption state of the host data 204A being the unencrypted state.

Similarly, if the processor 208 determines that the host data 204A may be in the encrypted state or the partially encrypted state at the host device 204, the processor 208 may include the corresponding padding bit pattern within the host data 204A to indicate that the expected encryption state of the host data 204A may be encrypted or partially encrypted, respectively. For example the host device 204 may send the data block 406 of the host data 204A in which bits corresponding to the host data 402 are appended with the padding bit pattern 404. For example, the data block 406 includes 16-bits of the host data 402 appended with 8-bits of the padding bit pattern 404. The data block 406 is sent to the processing circuitry 114A (or the storage controller 212), where the padding bit pattern 404 may correspond to the expected encryption state of the host data 204A. In one example, the padding bit pattern 404 within the data block 406 may include a multi-bit pattern (e.g., 2-bit pattern, 4-bit pattern, 8-bit pattern, 16-bit pattern, etc.) of zeros and ones to indicate the expected encryption state of the host data 204A. The padding bit pattern 404 may have a size (e.g., in kilobytes, number of bits used for representation, etc.) less than or equal to that of the host data 204A in each data block thereof to minimize any computational overhead and memory usage. The processing circuitry 114A (or the storage controller 212) may be further configured to receive from the host device 204, the host data 204A comprising the expected encryption state (indicated by the padding bit pattern 404) of the host data 204A based on the determining that the host device 204 may be participating in the encryption state communication.

The data block 402 and the data block 406 thus illustrate communication data exchange formats for legacy host devices and host devices configured for encryption state communication respectively. The data block 406 provides secure communication with storage device 202 because the additional padding bit pattern 404 is able to indicate state of encryption of the host data 204A to the storage device 202, which in turn is used to detect malware encryption by the storage device 202. However, in some communication protocols, indication of state of encryption of the host data 204A is not done through padding bit pattern. Rather, a dedicated communication block may be transmitted to indicate participation of the host device 204 in the encryption state communication.

FIG. 4C is a diagram that illustrates example communication blocks used for encryption state communication, in accordance with an embodiment of the disclosure. FIG. 4C illustrates an example of data exchange for a protocol where padding bit patterns are not used.

In an aspect of the present disclosure, a communication block 408 is transmitted to the storage device 202 to indicate a type of data block that would be followed next in the communication exchange. The communication block 408 is a dedicated command block that indicates to the storage device 202 the type of data block that the storage device 202 may receive. For example, the communication block 408 indicates that the next data block would be a host data block with expected encryption state as encrypted. Alternately, the communication block 408 indicates that the next data block would be a host data block with expected encryption state as partially encrypted. Alternately, the communication block 408 indicates that the next data block would be a host data block with expected encryption state as unencrypted. The communication block 408 is then followed by the actual data block, such as the data block 402 of the host data 204A, in an encryption state which was indicated by the communication block 408.

The communication block 408 may be transmitted from any of the host device 204 or the remote device 214, to the storage device 202 for enabling malware encryption detection.

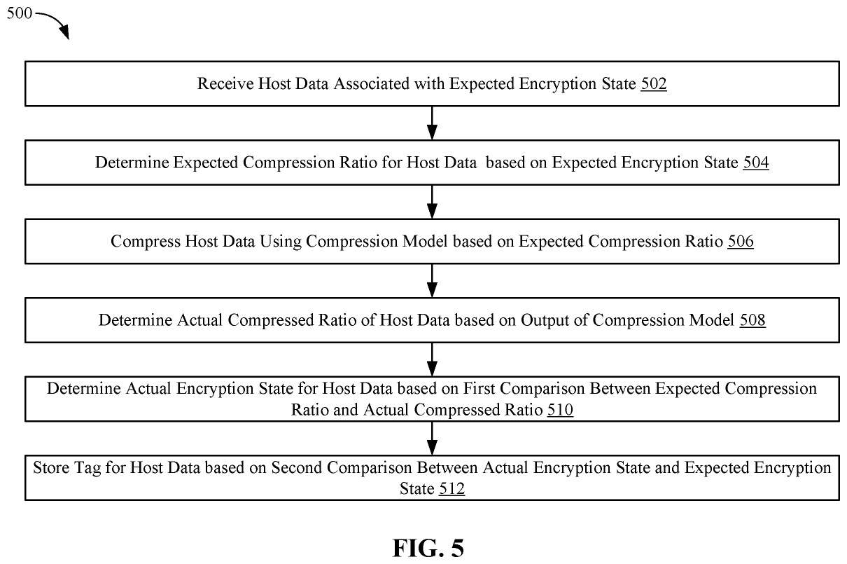

FIG. 5 is a flowchart that illustrates an exemplary method 500 for malware encryption detection, in accordance with an embodiment of the disclosure. FIG. 5 is explained in conjunction with elements from FIG. 1, FIGS. 2A-2B, FIG. 3, and FIGS. 4A-4B. In the illustrated embodiment, the processing circuitry 114A (or the storage controller 212) may implement an exemplary method 500 of FIG. 5. The operations of the exemplary method 500 may start at 502.

At 502, the host data 204A associated with the expected encryption state of the host data 204A may be received. In one embodiment, the processing circuitry 114A (or the storage controller 212) of the storage device 202 may be configured to receive the host data 204A comprising the expected encryption state. The expected encryption state may indicate to the processing circuitry 114A (or the storage controller 212) whether the host data 204A may be encrypted, unencrypted, or partially encrypted. For example, when the expected encryption state of the host data 204A may correspond to the encrypted state, then the processing circuitry 114A (or the storage controller 212) may expect to receive the host data 204A in the encrypted state from the host device 204. In an embodiment, based on participating in the encryption state communication, the host device 204 may insert the indication within the host data 204A to indicate the expected encryption state of the host data 204A. For example, if host data 204A may be unencrypted, the processor 208 of the host device 204 may include the padding bit pattern 404 shown in FIG. 4B within the host data 204A, where the padding bit pattern may correspond to the expected encryption state of the host data 204A being the unencrypted state.

At 504, the expected compression ratio for the host data 204A may be determined based on the expected encryption state of the host data 204A. In one embodiment, the processing circuitry 114A (or the storage controller 212) may be configured to determine the expected compression ratio for the host data 204A based on the expected encryption state of the host data 204A. The expected compression ratio may be an expectation on the host data 204A that how much the compression model 206 may be able to reduce the size of the received host data 204A. Examples of the size of the host data 204A may include, but are not limited to, 1 Kilobytes (KB), 1 Megabytes (MB), 1 Gigabytes (GB), and the like. The expected compression ratio of the host data 204A may be dependent on the expected encryption state of the host data 204A. Exemplary ranges of the expected compression ratio for each of an expected encryption states of the host data 204A are shown in a Table T1.

TABLE T1

| | | | Expected |
|---|---|---|---|
| | | | Compression |
| Expected Encryption State | | Compression Degree | Ratio Range |
| Unencrypted State | | Highly Compressible | 2:1 to 10:1 |
| Encrypted State | | Lower Compressible | 1:1 or less |
| Partially | Larger Unencrypted | Medium Compressible | 4:1 to 8:1 |
| Encrypted | Portion | | |
| State | Larger Encrypted | Lower Compressible | 1:1 or less |
| | Portion | | |

The table T1 including a relationship between the expected encryption states and the expected compression ratio ranges may be predetermined and stored in the persistent storage 120 of the storage device 202 for access by the processing circuitry 114A (or the storage controller 212) however, in some examples, the table T1 may be stored on the remote device 214 and accessed remotely by the processing circuitry 114A (or the storage controller 212) when required. The table T1 also illustrates a compression degree and an expected compression ratio range corresponding to different expected encryption states. In table T1, the expected encryption state column may indicate the expected encryption states of the host data 204A, the compression degree column may indicate a respective expected compression degree for each of the expected encryption states of the host data 204A, and the expected compression ratio range column may indicate a respective expected compression ratio range for each of the expected encryption states of the host data 204A.

In one example, the compression ratio may refer to a ratio of the size of the uncompressed data (e.g., uncompressed host data 204A) to the size of the compressed data (e.g., compressed host data 204A). The expected compression ratio may be represented as at least one of a fraction value, a percentage value, a ratio, and the like. As shown in Table T1, when the expected encryption state of the host data 204A may correspond to the unencrypted state, then the expected compression ratio may be determined, by the processing circuitry 114A (or the storage controller 212), to range from 2:1 to 10:1. Similarly, when the expected encryption state of the host data 204A may correspond to the encrypted state, then the expected compression ratio may be determined by the processing circuitry 114A (or the storage controller 212) as less than or equal to 1:1. Further, when the expected encryption state of the host data 204A may correspond to the partially encrypted state, then the expected compression ratio may be determined by the processing circuitry 114A (or the storage controller 212) based on a size of the encrypted portion of the host data 204A and the unencrypted portion of the host data 204A. For example, when the size of the unencrypted portion of the host data 204A may be greater than or equal to the size of the encrypted portion of the host data 204A, then the expected compression ratio for the host data 204A in the partially encrypted state may be determined, by the processing circuitry 114A (or the storage controller 212), ranging from 4:1 to 8:1. When the size of the unencrypted portion of the host data 204A may be less than the size of the encrypted portion of the host data 204A, then the expected compression ratio may be determined, by the processing circuitry 114A (or the storage controller 212), as less than or equal to 1:1.

In an embodiment, the determination of the expected compression ratio may be performed, based on the expected encryption state of the host data 204A and a type of the host data 204A. Examples of the type of the host data 204A may include, but are not limited to, a text type, an image type, a video type, an audio type, and the like, or any combinations thereof.

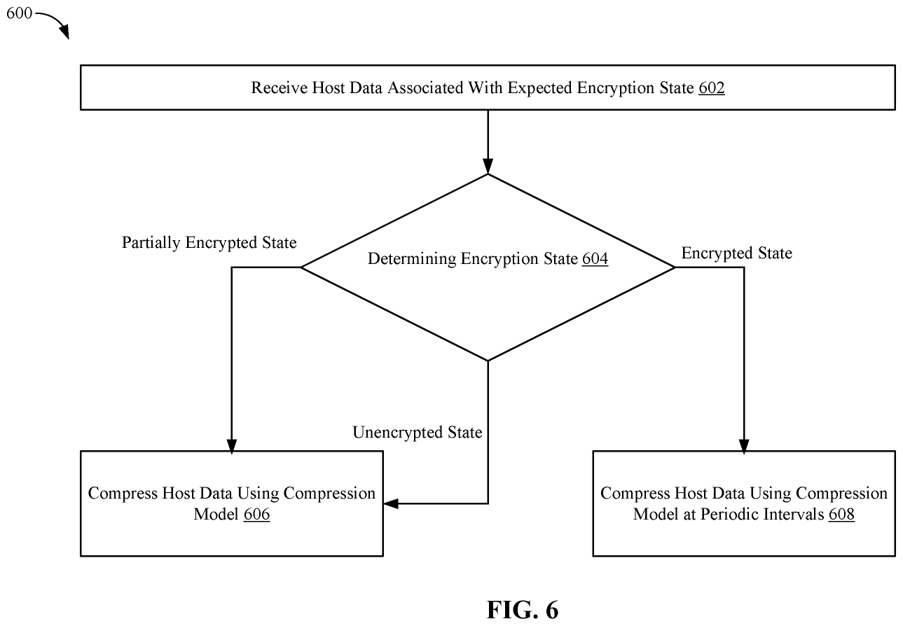

At 506, the host data 204A may be compressed using the compression model 206 based on the expected compression ratio of the host data 204A. In one embodiment, the processing circuitry 114A (or the storage controller 212) may be configured to compress the host data 204A using the compression model 206 based on the expected compression ratio of the host data 204A, discussed below in greater detail in conjunction with an exemplary method 600 shown in FIG. 6. The compression model 206 may use any suitable compression algorithm known in the art to reduce the size of the host data 204A. Examples of the compression algorithm for the compression model 206 may include, but are not limited to, a Run-Length encoding algorithm, a Huffman coding algorithm, a Lempel-Ziv-Welch (LZW) algorithm, a Deflate algorithm, a Burrows-Wheeler Transform (BWT) algorithm, an arithmetic algorithm, a data encoding algorithm, a Lempel-Ziv-Markov Chain Algorithm (LZMA), a Brotli algorithm, and a Run-Length Binary (RLBin). The compression model 206 may remove redundancies or irrelevancies in the host data 204A to reduce the size of the host data 204A, in some examples. In an embodiment, the expected compression ratio may be provided to the compression model 206 to compress the host data 204A based on the expected compression ratio. For example, when the expected compression ratio of the host data 204A may indicate the compression ratio of 2:1, then the compression model 206 may be configured to reduce the size of the host data 204A up to 50 percent.

At 508, the actual compressed ratio of the host data 204A may be determined based on the output of the compression model 206. The actual compressed ratio of the host data 204A is the actual output produced by the compression model 206. While the expected compression ratio is a predetermined or prestored ratio, which is expected as the output of the compression model 206, the actual compressed ratio is output of the compression model 206 actually produced. Differences or similarities between these two ratios are the basis on which malware detection using the method 500 is based. The storage device 202 and the storage controller 212 have limited processing capabilities, and limited visibility of state of the host data, which is further obscured if a malware is running on the storage device 202 to intercept the host data 204. The compression model 206 is a computationally efficient solution, which may be implemented at the storage device 202 or remotely (as already discussed in FIG. 2A and FIG. 2B) and uses available compression algorithms to compress the host data and determine the actual compressed ratio.

In one embodiment, the processing circuitry 114A (or the storage controller 212) may be configured to determine the actual compressed ratio of the host data 204A. For example, an original size ‘x’ may indicate the size of the host data 204A before the compression and a current size ‘y’ may indicate the size of the host data 204A after the compression. The actual compressed ratio of the host data 204A may be determined, by the processing circuitry 114A (or the storage controller 212), in a representation of at least one of a fraction value, a percentage value, and a ratio. The actual compressed ratio in the representation of the ratio may be represented by the following expression in Equation 1:

$$Actual compression ratio = ( x / y ) \qquad ( Equation 1 )$$

where x represents a size of the host data 204A before the compression, and
y represents a size of the host data 204A after the compression

Alternatively, the actual compressed ratio in the representation of the percentage may be represented by the following expression in Equation 2:

$$Actual compression ratio = ( ( x - y ) / x ) * 100 \qquad ( Equation 2 )$$

where x represents a size of the host data 204A before the compression,
y represents a size of the host data 204A after the compression, and
100 corresponds to a natural number

In an example, an original size of a data block of the host data 204A before compression may be 65 Bytes and the current size of the host data 204A after compression may be 43 Bytes. The actual compressed ratio based on Equation 1 is thus (65/43), which may be equal to 1.5116. Similarly, the actual compressed ratio in the representation of the percentage may be determined by the processing circuitry 114A (or the storage controller 212) based on Equation 2 as ((65−43)/65)*100, which may be equal to 34.15%.

At 510, the actual encryption state for the host data 204A may be determined based on the first comparison between the expected compression ratio of the host data 204A and the actual compressed ratio of the host data 204A. In one embodiment, the processing circuitry 114A (or the storage controller 212) may be configured to determine the actual encryption state for the host data 204A. The actual encryption state of the host data 204A is an indication of whether or not the host data 204A is compressed successfully according to the expected compression ratio.

In an aspect of the present disclosure, the expected encryption state of the host data 204A indicated by the padding bit pattern 404 may be the unencrypted state. Thus, based on the table T1, the expected compression ratio for the host data 204A is 2:1. Further, the compression model 206 also compresses the received host data 204A and determines the actual compressed ratio. When the malware is running on the storage device 202, it encrypts the received host data 204A prior to compression. Therefore the host data 204A that goes to the compression model 206 is already encrypted by the malware and the compression model 206 is not able to compress this data further. As a result the actual compressed ratio is determined to be 1:1. Now, when the processing circuitry 114A causes the first comparison between the expected compression ratio and the actual compressed ratio to be performed, they are found to be different and thus, the actual encryption state for the host data is now determined as encrypted as this host data is actually not compressible.

Thus, even though based on the expected encryption state, the host data 204A expected to be in the unencrypted state is a good candidate for the compression, but actually, even after being the good candidate for the compression, the host data is determined to be not compressible.

The non compressibility (or unsuccessful compression) of the host data 204A may occur due to a false expectation of the encryption state of the host data 204A. For example, as shown in the Table T2, the determined actual encryption state of the host data 204A may be different from the corresponding expected encryption state. If the actual encryption state may be the unencrypted state and the corresponding expected encryption state of the host data 204A may be encrypted state or partially encrypted state, the processing circuitry 114A (or the storage controller 212) may determine that the expected encryption state may be false. Similarly, the processing circuitry 114A (or the storage controller 212) may determine the expected encryption state received for the host data 204A as false if (i) the actual encryption state may be the encrypted state and the corresponding expected encryption state, as received, may be the partially encrypted state, and/or (ii) the actual encryption state may be the partially encrypted state but the corresponding expected encryption state, as received, may be the encrypted state. The processing circuitry 114A (or the storage controller 212) may provide an output to a user based on the received expected encryption state for the host data 204A determined to be false. The output may be displayed on the display device, or the display screen, either alone or in combination with a variety of tangible indicators (e.g., light emitting diodes, vibrators, speakers, etc.) or virtual indicators displayable on the display device, or the display screen. Examples of the virtual indicators may include, but are not limited to, numeric indicators, alphanumeric indicators, or non-alphanumeric indicators, such as colors, color luminance, symbols, patterns, textures, and graphical objects.

At 512, one or more tags for the host data 204A may be created and stored based on a second comparison between the actual encryption state of the host data 204A and the expected encryption state of the host data 204A. In one embodiment, the storage device 202 may be configured to create and store the tag for the host data 204A based on the second comparison. The stored tag indicates presence of malware in the communication when the expected encryption state and the actual encryption state differ.

In an embodiment of the present disclosure, the stored tag is updated for the host data 204A to indicate the malicious data in the host data 204A, where the malicious data may indicate the presence of a potential malware in the host data 204A, thereby creating a security threat.

Exemplary tag conditions for the host data 204A based on the second comparison between the actual encryption state of the host data 204A and the expected encryption state of the host data 204A is shown in Table T2.

TABLE T2

| Actual Encryption | Expected Encryption State of Host Data 204A | | |
|---|---|---|---|
| State of Host | Unencrypted | Encrypted | Partially |
| Data 204A | State | State | Encrypted State |
| Unencrypted | True Information | False | False |
| State | | Information | Information |
| Encrypted State | Tag Malicious Data | True | False |
| | | Information | Information |
| Partially | Tag Malicious Data | False | True |
| Encrypted State | | Information | Information |

Examples of the tags may include, but are not limited to, a single-bit or a multi-bit pattern in a data block of the host data 204A, a text, a graphic, a symbol, a numeric value, an alphanumeric value, a predefined function, and a color, or any combinations thereof. If the host data 204A is encrypted, the processing circuitry 114A (or the storage controller 212) may not be able to compress successfully to achieve a compression ratio of 1.1 or less. The processing circuitry 114A (or the storage controller 212) may create the tag based on the second comparison between the actual encryption state of the host data 204A and the expected encryption state of the host data 204A. For example, as shown in the Table T2, based on the second comparison, the processing circuitry 114A (or the storage controller 212) may be configured to create at least one of a first tag to indicate the malicious data in the host data 204A, a second tag to indicate a true information, and a third tag to indicate a false information. Each of the first tag, the second tag, and the third tag (collectively referred to as tags) are used by the processing circuitry 114A (or the storage controller 212) to identify whether or not the host data 204A includes (i) received data is good candidate for compression and/or storage, (ii) received data such as the host data 204A contains malicious data, and (iii) an indication on the encryption state status of the host data 204A to the host device and/or other networked devices. Hence, the tags may advantageously assist, for example, in (1) improving the performance of the processing circuitry 114A (or the storage controller 212), (2) creating an action plan to mitigate any security risk or threats due to the received data such as the host data 204A containing, e.g., malicious data, and (3) selectively reading and/or writing data on a computer readable medium, such as in the storage device 202, while reducing the computational burden and memory usage.

For example, as shown in the Table T2, when the expected encryption state of the host data 204A may indicate the unencrypted state and the actual encrypted state of the host data 204A may indicate the encrypted state, the processing circuitry 114A (or the storage controller 212) may associate a first tag, or update an existing or stored first tag, with the host data 204A to indicate the malicious data. Similarly, in another example, when the expected encryption state of the host data 204A may indicate the unencrypted state and the actual encryption state of the host data 204A may indicate the partially encrypted state, the processing circuitry 114A (or the storage controller 212) may associate another first tag, or update an existing or stored tag, for the host data 204A to indicate the malicious data.

Consider an example, if host data 204A is expected to be in the unencrypted state when written to the storage controller 212 from a host LPAR (e.g. host device 204) that participates in the encryption state communication, the host LPAR may insert the indication within the host data 204A to indicate that the expected encryption state of the host data 204A is unencrypted. Further, based on the determining the unsuccessful compression of the host data 204A, the actual encryption state the host data 204A may be determined as the encrypted state. To this end, the processing circuitry 114A (or the storage controller 212) may associate another first tag, or update an existing tag, for the host data 204A to indicate the malicious data.

In an embodiment, the indication of the malicious data may occur due to a false communication between the host device 204 and the storage device 202. For example, when the processing circuitry 114A (or the storage controller 212) may expect to receive the host data 204A in the unencrypted state, but the host data 204A may be received in the encrypted state or the partially encrypted state. In one example, the false communication may occur due to an unauthorized third party intrusion between the host and the storage device 202 during a transmission of the host data 204A. Continuing with the present example, where the unauthorized third party may forcefully encrypt or partially encrypt the host data 204A without knowledge of the host device 204 or the storage device 202, to potentially cause the several security threats, the processing circuitry 114A may associate the first tag with the host data 204A to indicate the malicious data.

In an embodiment, the host data 204A tagged with the false information may be examined by the processing circuitry 114A (or the storage controller 212) to detect whether the host data 204A may be malicious. Further, the processing circuitry 114A (or the storage controller 212) may update the stored tag for the host data 204A to indicate the malicious data based on the detecting the host data 204A containing malicious data at a different time interval.

In an embodiment, the processing circuitry 114A (or the storage controller 212) may be further configured to delete the malicious data before the occurrence of any security risks or threats. Additionally, in some examples, the processing circuitry 114A (or the storage controller 212) may stop the transmission of the host data 204A, e.g., which contains the malicious data, from the host device 204 for a predetermined time period. In this manner, the processing circuitry 114A may be configured to use the stored tags to identify the malicious data and provide a secure and reliable transmission of the host data 204A between the host device 204 and the storage device 202 by preventing several security threats. To this end, the compression model 206 performing compression of the received host data 204A is an important precursor to determining the tags which ultimately qualify the host data 204A as malicious or not malicious.

FIG. 6 is a flowchart that illustrates an exemplary method 600 for compressing the host data 204A based on the expected encryption state of the host data 204A, in accordance with an embodiment of the disclosure. FIG. 6 is explained in conjunction with elements from FIG. 1, FIGS. 2A-2B, FIG. 3, FIGS. 4A-4C, and FIG. 5. With reference to FIG. 6, there is shown the exemplary method 600. The operations of the exemplary method 600 may be executed by any computing system, for example, by the processing circuitry 114A (or the storage controller 212). The operations of the flowchart 600 may start at 602.

At 602, the host data 204A associated with the expected encryption state of the host data 204A may be received. In one embodiment, the processing circuitry 114A (or the storage controller 212) may be configured to receive the host data 204A associated with the expected encryption state. Details about the receiving the host data 204A comprising the expected encryption state are provided, for example, in FIGS. 2A-2B and FIG. 5.

At 604, the expected encryption state of the host data 204A is determined. In one embodiment, the processing circuitry 114A (or the storage controller 212) may be configured to determine the expected encryption state of the host data 204A. If the expected encryption state, as received, indicates the encrypted state, operation 608 is executed. Alternatively, on determining the expected encryption state, indicating at least one of the partially encrypted state and the unencrypted state, the processing circuitry 114A (or the storage controller 212) proceeds to execute operation 606.

At 606, the processing circuitry 114A (or the storage controller 212) may be configured to input the host data 204A to the compression model 206 for compressing the host data 204A. Inputting the host data 204A in the unencrypted state or the partially encrypted state to the compression model 206 may provide a significant benefit in terms of storage efficiency and security. The output of the compression model 206 is used to determine the actual encryption state of the host data, as described in conjunction with FIG. 5, which in turn is used to qualify the data as malicious or not malicious. The malicious data is further prevented from being written to the storage device 202 to avoid potential security threats.

When the host data 204A is in the encrypted state, operation 608 includes compressing host data 204A only periodically. As is already discussed, the encrypted state of the host data 204A may due to two causes, (1) the host data is actually encrypted, and (2) the host data was encrypted but a malware caused the host data to be encrypted.

Considering cause (1), when the host data is actually encrypted and expected encryption state of the host data is also encrypted state, using the compression model 206 to try to compress the data leads to wastage of computational resources. Therefore, rather than using the compression model 206 every time host data in expected encryption state as encrypted, is received, random periodic checks on such host data may be done to utilize computing resources efficiently. Such random checks may be done at periodic intervals. This random checking also ensures catching bit padding pattern errors, which may have caused changes to expected encryption state. If during such random checks, multiple instances of false information are identified, this may be used to indicate presence of malicious activity.

Thus, at 608, the host data 204A may be compressed using the compression model 206 at periodic intervals. On determining that the expected encryption state, as received, of the host data 204A indicating the encrypted state, the processing circuitry 114A (or the storage controller 212) may be configured to input the host data 204A to the compression model 206 at the periodic intervals. Examples of the periodic intervals may include, but are not limited to, one second after a current time, one minute after a current time, one hour after a current time, and the like.

Inputting the host data 204A expected to be in the encrypted state to the compression model 206 at periodic intervals may be beneficial in verifying the expected encryption state of the host data 204A. In order to ensure the consistency of the actual encryption state of the host data 204A, the processing circuitry 114A (or the storage controller 212) may select the periodic intervals randomly, to test the host data 204A. At the randomly selected periodic intervals, the host data 204A is inputted to the compression model 206 to test the host data 204A. In an embodiment of the disclosure, the host device 204 sends encrypted data and the expected encryption state of the host data 204A is encrypted state. However, after compression, the actual encryption state of the host data 204A is determined as unencrypted state, for example, based on the corresponding expected compression degree or ratio, as discussed above with respect to Table T1. This discrepancy in the expected encryption state and the actual encryption state indicates that false information may be stored in a padding bit pattern, such as the padding bit pattern 404 of the host data 204A. The false information stored indicates a bug in the transmission of the padding bit pattern, such as the padding bit pattern 404, thereby assisting in verifying a veracity of the received expected encryption state of the received data such as the host data 204A.

Referring to the causes of encryption of host data, the cause (2) that the host data was encrypted but a malware caused the host data to be encrypted is also identified by such periodic checking.

The method 600 ensures saving bandwidth and computing resources and at the same time providing effective malware detection using the various operations described above.

Various embodiments of the disclosure may provide a non-transitory computer readable medium and/or storage medium having stored thereon, instructions executable by a machine and/or a computer to operate a system (e.g., the storage device 202) for malware encryption detection. The instructions may cause the machine and/or computer to perform operations that include receive host data comprising an expected encryption state of the host data, where the expected encryption state includes at least one of an encrypted state, a partially encrypted state, or an unencrypted state. The instructions may further cause the machine and/or computer to compress the host data using a compression model based on an expected compression ratio, and determine, based on an output of the compression model, an actual compressed ratio of the host data. The instructions further may cause the machine and/or computer to determine an actual encryption state for the host data based on a first comparison between the expected compression ratio of the host data and the actual compressed ratio of the host data. The instructions may further cause the machine and/or computer to store a tag for the host data based on a second comparison between the actual encryption state of the host data and the expected encryption state of the host data.

Many modifications and other embodiments of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

We claim:

1. A computer-implemented method comprising:
receiving host data associated with an expected encryption state of the host data, wherein the expected encryption state includes at least one of: an encrypted state, a partially encrypted state, or an unencrypted state;
determining an actual encryption state for the host data based on a first comparison between an expected compression ratio of the host data and an actual compressed ratio of the host data; and
storing a tag for the host data based on a second comparison between the actual encryption state of the host data and the expected encryption state of the host data.

2. The computer-implemented method of claim 1, further comprising:
updating the stored tag for the host data to indicate malicious data based on the determining the expected encryption state of the host data indicates the unencrypted state and the actual encryption state of the host data indicates the encrypted state.

3. The computer-implemented method of claim 1, wherein the expected compression ratio for the host data is determined based on the expected encryption state of the host data.

4. The computer-implemented method of claim 1, further comprising:
inputting the host data to a compression model, the compression model configured to compress the host data based on the expected compression ratio; and
determining, based on an output of the compression model, the actual compressed ratio of the host data.

5. The computer-implemented method of claim 4, further comprising:
inputting the host data to the compression model based on the determining the expected encryption state of the host data indicates at least one of: the partially encrypted state or the unencrypted state.

6. The computer-implemented method of claim 4, further comprising:
inputting the host data to the compression model at periodic intervals based on the determining the expected encryption state of the host data indicates the encrypted state.

7. The computer-implemented method of claim 1, further comprising:
transmitting a first message to a host, wherein the first message is transmitted to determine a participation of the host in an encryption state communication;
receiving, based on the transmitted first message, a second message from the host, wherein the second message indicates the participation of the host in the encryption state communication; and
receiving, from the host, the host data associated with the expected encryption state of the host data based on the determining, using the received second message, that the host is participating in the encryption state communication.

8. A system, comprising:
a processing circuitry configured to:
receive host data associated with an expected encryption state of the host data, wherein the expected encryption state includes at least one of: an encrypted state, a partially encrypted state, or an unencrypted state;
compress the host data using a compression model based on an expected compression ratio;
determine, based on an output of the compression model, an actual compressed ratio of the host data;
determine an actual encryption state for the host data based on a first comparison between the expected compression ratio of the host data and the actual compressed ratio of the host data; and
store a tag for the host data based on a second comparison between the actual encryption state of the host data and the expected encryption state of the host data.

9. The system of claim 8, wherein the processing circuitry is further configured to:
update the stored tag for the host data to indicate malicious data based on the determining the expected encryption state of the host data indicates the unencrypted state and the actual encryption state of the host data indicates the encrypted state.

10. The system of claim 8, wherein the expected compression ratio for the host data is determined based on the expected encryption state of the host data.

11. The system of claim 8, wherein the processing circuitry is further configured to:
compress the host data using the compression model based on the determining the expected encryption state of the host data indicates at least one of: the partially encrypted state or the unencrypted state.

12. The system of claim 8, wherein the processing circuitry is further configured to:
compress the host data using the compression model at periodic intervals based on the determining the expected encryption state of the host data indicates the encrypted state.

13. The system of claim 8, wherein the processing circuitry is further configured to:
transmit a first message to a host, wherein the first message is transmitted to determine a participation of the host in an encryption state communication;
receive a second message from the host based on the transmitted first message, wherein the second message indicates the participation of the host in the encryption state communication; and
receive, from the host, the host data associated with the expected encryption state of the host data based on the determining, using the received second message, that the host is participating in the encryption state communication.

14. A computer program product for malware encryption detection, the computer program product comprising a computer readable storage medium having program instructions embodied therewith, the program instructions executed by a system to cause the system to:
receiving host data associated with an expected encryption state of the host data, wherein the expected encryption state includes at least one of: an encrypted state, a partially encrypted state, or an unencrypted state;
determining an actual encryption state for the host data based on a first comparison between an expected compression ratio of the host data and an actual compressed ratio of the host data;
storing a tag for the host data based on a second comparison between the actual encryption state of the host data and the expected encryption state of the host data; and
updating the stored tag for the host data to indicate malicious data based on the determining the expected encryption state of the host data indicates the unencrypted state and the actual encryption state of the host data indicates the encrypted state.

15. The computer program product of claim 14, wherein the expected compression ratio of the host data is determined based on the expected encryption state of the host data.

16. The computer program product of claim 14, wherein the system is further configured to:
inputting the host data to a compression model, the compression model configured to compress the host data based on the expected compression ratio; and
determining, based on an output of the compression model, the actual compressed ratio of the host data.

17. The computer program product of claim 14, wherein the system is further configured to:
updating the actual encryption state for the host data to an encryption state based on the determining the actual compressed ratio of the host data is less than the expected compression ratio.

18. The computer program product of claim 16, wherein the system is further configured to:
inputting the host data to the compression model based on the determining the expected encryption state of the host data indicates at least one of: the partially encrypted state or the unencrypted state.

19. The computer program product of claim 16, wherein the system is further configured to:
inputting the host data to the compression model at periodic intervals based on the determining the expected encryption state of the host data indicates the encrypted state.

20. The computer program product of claim 14, wherein the system is further configured to:
transmit a first message to a host, wherein the first message is transmitted to determine a participation of the host in an encryption state communication;
receive a second message from the host based on the transmitted first message, wherein the second message indicates the participation of the host in the encryption state communication; and
receive, from the host, the host data associated with the expected encryption state of the host data based on the determining, using the received second message, that the host is participating in the encryption state communication.
